(19) United States
(12) Patent Application Publication
(10) Pub. No.: US 2026/0021446 A1
(43) Pub. Date: Jan. 22, 2026

(54) WATER PRECIPITATING DEVICES, METHODS AND SYSTEMS

(71) Applicant: BEAIR WATER AND AIR TECHNOLOGIES LTD., Jerusalem (IL)

(72) Inventor: Joshua Lewis COLMAN, Jerusalem (IL)

(21) Appl. No.: 19/105,409

(22) PCT Filed: Aug. 21, 2023
(86) PCT No.: PCT/IL2023/050882

§ 371 Date: Feb. 21, 2025

Related U.S. Application Data
(60) Provisional application No. 63/399,820, filed on Aug. 22, 2022.

(51) Int. Cl. B01D 53/26; B01D 5/00; B01D 53/22; B01D 53/30; B01D 71/76; E03B 3/28

(52) U.S. Cl. CPC B01D 53/268; B01D 5/0003; B01D 53/227; B01D 53/30; B01D 71/76; E03B 3/28; B01D 2053/223; B01D 2257/80

(57) ABSTRACT

Provided herein are systems, devices and methods for generating water from ambient air, by implementing a water vapor separation unit, including one or more selective membranes, configured to selectively separate/transfer water vapor form the ambient air, and a water precipitation unit, including a plurality of cooling elements, configured for precipitating the selectively separated water vapor from the ambient air.

### TECHNICAL FIELD

The present disclosure relates generally to devices, methods and systems for generating water from ambient air.

### BACKGROUND

Increased water pollution and limited availability of freshwater resources have become growing reasons for concern and pose major global challenges. Atmospheric water generation (AWG) is a renewable and environmentally friendly technique which has been regarded as one of the promising solutions for mitigating the freshwater scarcity. In contrast to its counterparts, such as solar desalination, which require access to water sources, AWG utilizes the ambient air, and specifically the humidity present in the ambient air, for the generation of clean water therefrom. Specifically, the AWG techniques are based on harvesting water vapor originating from the ambient air and transforming it into liquid water. However, this process typically requires high energy consumption for the phase transformation of water as well as for latent heat removal. For example, PCT application number WO 2019/229749 is directed to atmospheric water generation method, device and system.

Nevertheless, there is a need in the art for efficient methods and devices for generating water from air.

### SUMMARY

According to some embodiments, there are provided systems, devices and methods for separating/transferring water vapor molecules from ambient air, and precipitating selectively separated/transferred water vapor for generation of liquid water. Advantageously, the precipitation is performed by condensing essentially only the selectively separated water vapor molecules, thereby reducing the energy consumption, and increasing the efficiency thereof.

According to some embodiments, there are provided herein devices for precipitating water from ambient air, the devices include a water vapor separation unit having one or more selective membranes configured to selectively separate/transfer water vapor from the ambient air. Advantageously, according to some embodiments, the one or more selective membranes having high water vapor permeability and high impermeability to other various gases and/or contaminants, such that no additional filtering/purification is required. According to some embodiments, the one or more selective membranes are self-supporting. According to some embodiments, the one or more selective membranes maintain their shape and structure (e.g., essentially no surface distortions forming thereon) during continuous contact with water and humid environment. According to some embodiments, the one or more selective membranes include a plurality of tubes, advantageously increasing the selective surface to volume ratio, thereby increasing the water vapor separation rate and/or volume.

According to some embodiments, there is provided a device for generating water from ambient air, the device includes a water vapor separation unit having one or more selective membranes configured to selectively separate/transfer water vapor from the ambient air passing along the one or more selective membranes; and a water precipitation unit including a plurality of cooling elements, configured for precipitating the selectively separated water vapor to allow collection of precipitated water droplets in a water collection unit, wherein a continuous gradient of water vapor concentration and/or pressure is maintained across the one or more selective membranes, and wherein each of the one or more selective membranes of the water vapor separation unit is adjacent to at least one of the plurality of cooling elements of the water precipitation unit.

According to some embodiments, each of the one or more selective membranes is selectively permeable to water vapor and is essentially impermeable to bacteria, viruses or other airborne contaminants.

According to some embodiments, the one or more selective membranes include or made of a non-porous membrane.

According to some embodiments, the one or more selective membranes include or made of one of more of: Nafion, Aquivion, Flemion and Perfluorosulfonic acid.

According to some embodiments, the one or more selective membranes comprise or made of non-porous membranes impregnated with Nafion solution.

According to some embodiments, each of the one or more selective membranes may be arranged parallelly to the longitudinal axis of the device.

According to some embodiments, the one or more selective membranes may be arranged in a periodic and/or close packed configuration.

According to some embodiments, the one or more selective membranes are in the form of a plurality of tubes, a plurality of sheets, or a combination thereof.

According to some embodiments, wherein the one or more selective membranes are in the form of a plurality of tubes, each of the plurality of tubes having a diameter of at least about 1.5 mm.

According to some embodiments, wherein the one or more selective membranes are in the form of a plurality of tubes, each of the plurality of tubes having a diameter in the approximate range of 3-5 mm.

According to some embodiments, wherein the one or more selective membranes are in the form of a plurality of tubes, each of the plurality of tubes having a length to diameter ratio of at least about 100 to 1.

According to some embodiments, wherein the one or more selective membranes are in the form of plurality of sheets, the distance between each of the plurality of sheets may be in the approximate range of 2-6 mm.

According to some embodiments, the ambient air flow speed through the water vapor separation unit of the device is at least about 5 m/sec.

According to some embodiments, the ambient air flow speed through the water vapor separation unit of the device is at least about 10 m/sec.

According to some embodiments, the plurality of cooling elements includes a cooling surface.

According to some embodiments, the distance between an outer surface each of the one or more selective membranes and the cooling surface is in the approximate range of 3-4 mm.

According to some embodiments, the cooling surface of the plurality of cooling elements includes an outer super hydrophobic layer, coating or surface.

According to some embodiments, the cooling surface of the plurality of cooling elements includes one or more islands of hydrophilic material to facilitate nucleation of liquid water droplets.

According to some embodiments, the plurality of cooling elements are tubular elements comprising a cooling fluid in a cavity thereof.

According to some embodiments, wherein the one or more selective membranes include the plurality of tubes, the plurality of tubes and the cooling elements are at least partially concentric.

According to some embodiments, the plurality of cooling elements is configured to allow fast release of the precipitated water droplets therefrom, thereby facilitating maintaining the water vapor concentration and/or pressure gradient.

According to some embodiments, the precipitating of water vapor into liquid water (i.e., condensation) in the water precipitation unit is facilitated by cooling the water vapor to reach a dew point and consequent condensing the water vapor to form the liquid water.

According to some embodiments, the device may include one or more of: a pump an air moving device, or any combination thereof. According to some embodiments, the air moving devices may include low-power devices, such as bot not limited to, fans, blowers, and the like, or any combination thereof.

According to some embodiments, the device may include a desiccant unit configured to extract remnant water vapor.

According to some embodiments, the device may include a control unit, configured to control operation of the device.

According to some embodiments, the device may include one or more sensors configured to measure various operating parameters of the device, and/or environment-related parameters. According to some embodiments, the operating parameters and/or the environment-related parameters are selected from: ambient temperature, relative humidity, barometric pressure, internal temperature in various compartments of the device, air flow speed to and/or within the device, pump level, pump throughput, pressure gradient, cooling level, vacuum levels, water removal rate, amount of generated water, daylight time, or any combination thereof.

According to some embodiments, the water collection unit of the device is positioned at least partially beneath the water precipitation unit.

According to some embodiments, the device may be portable.

According to some embodiments, there is provided herein a method for generating water from ambient air. According to some embodiments, the method includes introducing an ambient air flow into a water vapor separation unit, the water vapor separation unit having one or more selective membranes configured to selectively separate/transfer water vapor from the ambient air passing along the one or more selective membranes, precipitating the selectively separated/transferred water vapor into liquid water droplets in a water precipitation unit by a plurality of cooling elements, and collecting the liquid water droplets in a water collection unit.

According to some embodiments, the precipitation of the liquid water is performed by cooling the selectively separated/transferred water vapor to reach a dew point, and consequent condensing the water vapor to form the liquid water.

According to some embodiments, the method may further include processing of the liquid water. According to some embodiments, the processing includes, among others, ionizing, or otherwise enriching the precipitated liquid water with elements/substances, collecting the liquid water in reservoirs, containers, bottles, and the like, or any combination thereof.

According to some embodiments, the method may further include enriching the ambient air flow introduced into the water vapor separation unit with humidity.

According to some embodiments, the method may include periodically reversing a fluid flow direction, wherein the reversing includes: reversing the fluid flow direction of an air moving device; heating at least a portion of a desiccant unit to release remnant water vapor therefrom; and recirculating back the remnant water vapor released from the desiccant unit into the water vapor separation unit.

According to some embodiments, the method may include sensing or measuring one or more parameters, selected from: ambient temperature, relative humidity. barometric pressure, partial water vapor pressure, or any combination thereof.

Certain embodiments of the present disclosure may include some, all, or none of the above advantages. One or more other technical advantages may be readily apparent to those skilled in the art from the figures, descriptions, and claims included herein. Moreover, while specific advantages have been enumerated above, various embodiments may include all, some, or none of the enumerated advantages.

Unless otherwise defined, all technical and scientific terms used herein have the same meaning as commonly understood by one of ordinary skill in the art to which this disclosure pertains. In case of conflict, the patent specification, including definitions, governs. As used herein, the indefinite articles “a” and “an” mean “at least one” or “one or more” unless the context clearly dictates otherwise.

### BRIEF DESCRIPTION OF THE FIGURES

Some embodiments of the disclosure are described herein with reference to the accompanying figures. The description, together with the figures, makes apparent to a person having ordinary skill in the art how some embodiments may be practiced. The figures are for the purpose of illustrative description and no attempt is made to show structural details of an embodiment in more detail than is necessary for a fundamental understanding of the disclosure. For the sake of clarity, some objects depicted in the figures are not drawn to scale. Moreover, two different objects in the same figure may be drawn to different scales. In particular, the scale of some objects may be greatly exaggerated as compared to other objects in the same figure.

In block diagrams and flowcharts, optional elements/components and optional stages may be included within dashed boxes. In the figures:

FIG. 1A shows a schematic block diagram of a system for precipitating water from atmospheric/ambient air, according to some embodiments;

FIG. 1B shows a schematic block diagram of a system for precipitating water from atmospheric/ambient air including a desiccant unit, according to some embodiments;

FIG. 2A schematically illustrates a cross-sectional side view of a device for precipitating water from ambient air, according to some embodiments;

FIG. 2B schematically illustrates a cross-sectional top view of the device in FIG. 2A, according to some embodiments;

FIG. 3 schematically illustrates a dew point temperature profile at a cross-sectional side view of a device for precipitating water from ambient air, according to some embodiments;

FIG. 4A. schematically illustrates a perspective side view of an air moving device having an assemblable aerodynamic structure, prior to assembling thereof, according to some embodiments;

FIG. 4B schematically illustrates a perspective side view of a metal frame of the aerodynamic structure of the air moving device of FIG. 4A, according to some embodiments;

FIGS. 4C-4D schematically illustrate a perspective side view of an assemblable aerodynamic structure prior to assembling thereof, and a side view after assembling thereof, according to some embodiments; and

FIGS. 4E-4F schematically illustrate a perspective side view of an assemblable aerodynamic structure prior to assembling thereof, and a side view after assembling thereof, according to some embodiments.

FIG. 5 is a flow chart of a method for precipitating water from ambient air, according to some embodiments.

### DETAILED DESCRIPTION

The principles, uses and implementations of the teachings herein may be better understood with reference to the accompanying description and figures. Upon perusal of the description and figures present herein, one skilled in the art will be able to implement the teachings herein without undue effort or experimentation. In the figures, same reference numerals refer to same parts throughout.

In the following description, various aspects of the invention will be described. For the purpose of explanation, specific details are set forth in order to provide a thorough understanding of the invention. However, it will also be apparent to one skilled in the art that the invention may be practiced without specific details being presented herein. Furthermore, well-known features may be omitted or simplified in order not to obscure the invention.

According to some embodiments, the disclosed systems, devices and methods continuously and selectively separate/transfer water molecules from a gaseous/fluid thereby continuous precipitation of the selectively mixture, allowing separated/transferred water molecules. Hence, reducing the amount of the external energy required for the processing and increasing the efficiency thereof.

According to some embodiments, there are provided herein systems, devices and methods for generating water from ambient air, the systems, devices and methods include a water vapor separation unit having one or more selective membranes configured to selectively separate/transfer water vapor from the ambient air passing along the one or more membranes, and a water precipitation unit, having a plurality of cooling elements, configured for precipitating the water vapor into liquid water droplets, wherein each of the one or more selective membranes in the water vapor separation unit is adjacent to at least one of the plurality of cooling elements of the water precipitation unit.

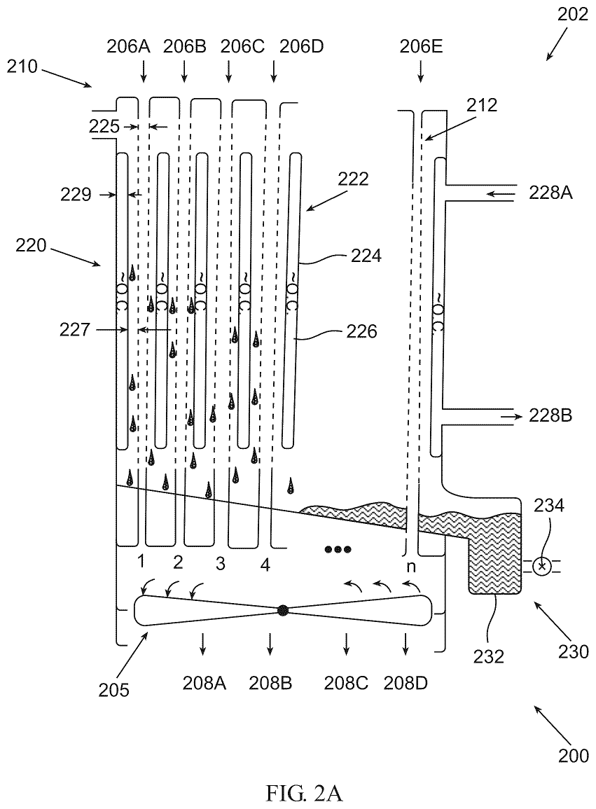

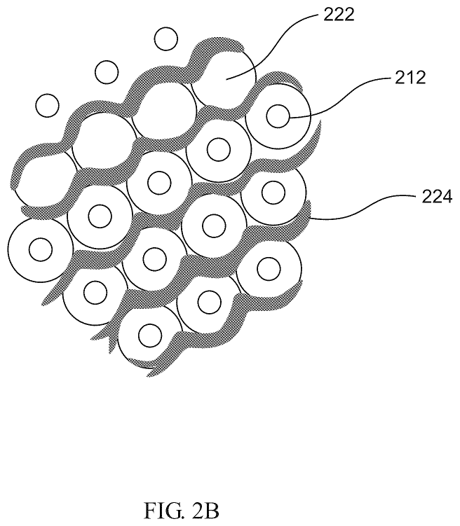

According to some embodiments, the one or more selective membranes positioned in the water vapor separation unit (as further depicted in FIGS. 2A-2B) advantageously allow essentially selective processing (e.g., condensation/cooling) of the water vapor Put differently, the ambient air introduced into the system typically includes a mixture of various gases/fluids/species, each having different physical and chemical characteristics, while processes like cooling are not molecule-specific and are typically performed on the entire content of the mixture. In particular, when at least one of the species in the mixture is more volatile than at least a second less volatile species, the processing will be less efficient. The efficiency will further decrease in the case wherein the at least one of the more volatile species is present in the mixture at lower concentration than the at least second less volatile species. It is also understood by skilled in the art that the processing procedures, like cooling, also depend on the initial temperature of the mixture, the temperature required for the processing (i.e., cooling until dew point temperature is reached), the initial relative humidity conditions of the mixture, partial pressures, etc. In contrast to spontaneously occurring processes, in which, according to the laws of thermodynamics, heat energy is transferred from a hot state to a cold state until equilibrium is reached, processes like cooling below the ambient temperature require providing external energy. The amount of the external energy provided for cooling takes into consideration not only the required energy for reaching the dew point temperature, which is usually significantly lower than the initial temperature of the mixture, but also the energy required for removing the latent heat of condensation. For instance, a gaseous mixture of air and water vapor at room temperature with relative molar concentrations of air 95% and water vapor 5% is condensed for generating liquid water therefrom by reducing the temperature of the whole mixture until the relative dew point temperature is reached. Hence it is evident that in such a scenario, wherein for cooling 5 molecules of water vapor, 95 air molecules are cooled as well, high amounts of energy are consumed, rendering the process highly inefficient. The efficiency further decreases when the process is performed continuously and/or production of high volumes of liquid water is required. It is further understood by one skilled in the art that in order to provide the driving force for initiation of the condensation process, it is necessary not only to reach the dew point temperature but to surpass it. Consequently, rendering the process in the abovementioned example even more energy consuming.

According to some embodiments, the one or more selective membranes advantageously maintain their shape and structure (e.g., essentially no surface distortions forming thereon) during continuous contact with water and humid environment. According to some embodiments, the one or more selective membranes are self-supporting, thus requiring no or minimal supporting means to facilitate the mechanical stability. In some embodiments, the one or more selective membranes may be associated with one or more supporting means to facilitate the mechanical stability thereof.

According to some embodiments, the one or more selective membranes configured to selectively separate/transfer the water vapor molecules across opposing surfaces thereof, while essentially preventing/blocking the transport of other species/substances. According to some embodiments, the configuration of the one or more selective membranes may vary. According to some embodiments, the one or more selective membranes may include a planar configuration, such as sheets. According to some embodiments, the one or more selective membranes may include a tubular configuration. According to some embodiments, the one or more selective membranes may include various combined configurations, such as planar and tubular configurations. Each possibility is a separate embodiment.

As used herein, the terms “generating water” and “precipitating water” are interchangeable. The terms relate to precipitation of liquid water from specifically separated water vapor from the ambient air by the methods, devices and systems disclosed herein. It is understood that the precipitated liquid water may be further processed, e.g., collected in reservoirs, containers, bottles, ionized or otherwise enriched with elements/substances, and the like, or any combination thereof.

As used herein, the term “water vapor” relates to the gaseous phase of water.

As used herein, the terms “atmospheric air” and “ambient air” may interchangeably be used herein.

As used herein, the term “room temperature” related to the temperature in the environment in which the disclosed systems and devices operate.

As used herein, the term “condensation” relates to the change of the physical state of the water vapor (i.e., gaseous state of water) into the liquid state (i.e., liquid water/droplets of water). In some embodiments, condensation is the reverse of vaporization, where the liquid turns to gas phase.

In the description and claims of the application, the words “include” and “have”, and forms thereof, are not limited to members in a list with which the words may be associated.

As used herein, the term “about” may be used to specify a value of a quantity or parameter (e.g., the length of an element) to within a continuous range of values in the neighborhood of (and including) a given (stated) value. According to some embodiments, “about” may specify the value of a parameter to be between 80% and 120% of the given value. For example, the statement “the length of the element is equal to about 1 m” is equivalent to the statement “the length of the element is between 0.8 m and 1.2 m”. According to some embodiments, “about” may specify the value of a parameter to be between 90% and 110% of the given value. According to some embodiments, “about” may specify the value of a parameter to be between 95% and 105% of the given value.

As used herein, according to some embodiments, the terms “essentially”, “approximately”, and “about” may be interchangeable.

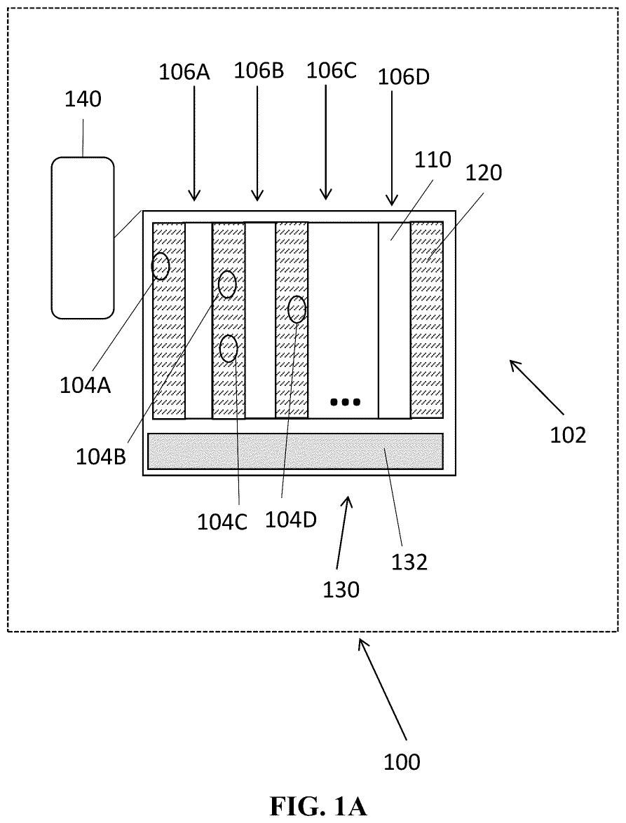

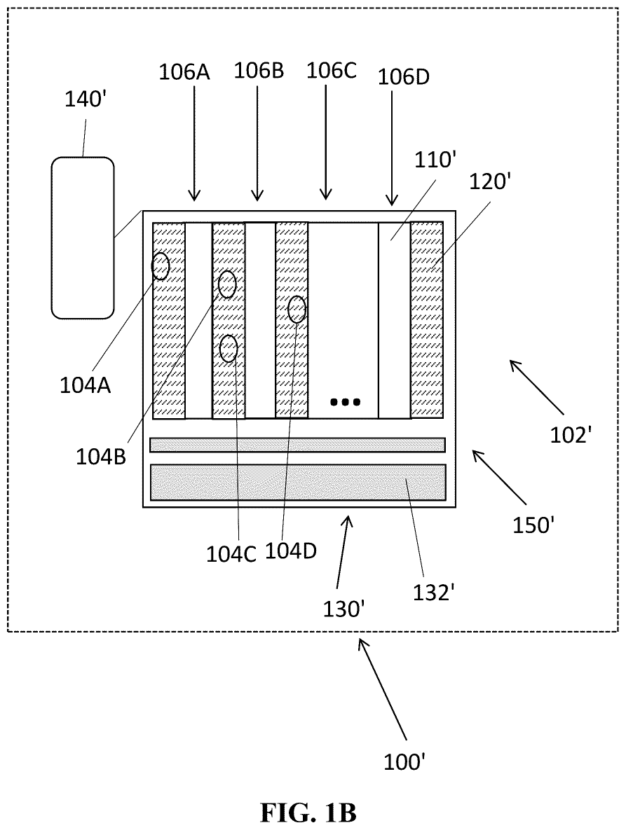

Reference is now made to FIG. 1A, which schematically illustrates a block diagram of a system 100 and a device 102 for precipitating water from atmospheric/ambient air, according to some embodiments. As shown in FIG. 1A, device 102 includes a water vapor separation unit 110 and a water precipitation unit 120.

According to some embodiments, the water vapor separation unit 110 includes one or more selective membranes (as further depicted in FIG. 2A and FIG. 2B) configured to selectively separate/transfer the water vapor from ambient air (marked as arrows 106A-106D) passing therethrough.

According to some embodiments, the one or more selective membranes are configured for selectively separating specific molecules across opposing surfaces/sides thereof while essentially preventing the passage of other substances present in the ambient air. According to some embodiments, without wishing to be bound to any theory or mechanism, the selective separating is based on a diffusion mechanism. The rate and efficiency of transport across the plurality of tubes and/or sheets are dependent mainly upon the type of molecule/ion, the partial pressure gradient across it, the surface area and thickness of sheet or tubular walls, water activity, ambient temperature, the flow speed at the wall surface, and the like, or any combination thereof. According to some embodiments, the water vapor may be transported across the one or more selective membranes at high transport rates. According to some embodiments, the transport rates depend on the gradient created across the opposing surfaces/sides of the one or more selective membranes. According to some embodiments, the gradient is continuous and maintained by providing differences of the physical characteristics on either surfaces/sides of each of the one or more selective membranes, such as but not limited to, pressure, temperature, and/or concentration. As a non-limiting example, the gradient may include water vapor concentration gradient.

According to some embodiments, the difference of the physical characteristics may be maintained by introducing ambient air across a first surface/side of each of the one or more selective membranes and/or by removing the matter of interest (e.g., water vapor molecules) from a second (i.e., opposing) surface/side of each of the one or more selective membranes, continuously transforming the water vapor molecules into liquid water droplets on a cooling surface of a plurality of cooling elements, and allowing natural and/or fast release of the water droplets from the cooling surface. Hence, advantageously driving and enabling a continuous cyclic process of water vapor separation and liquid water generation.

According to some embodiments, the selectively separated water vapor enters the water precipitation unit 120 and is further processed to result in the generation of pure water (represented by liquid water droplets 104A-104D). According to some embodiments, the water precipitation unit 120 includes a plurality of cooling elements (further depicted in FIGS. 2A-2B), configured for cooling and precipitating the selectively separated/transferred water vapor into liquid water droplets 104A-104D. According to some embodiments, the precipitation of liquid water droplets 104A-104D occurs by achieving condensation conditions-cooling the water vapor in order to reach a dew point. i.e., a relative humidity (RH) of 100%. According to some embodiments, the condensation is advantageously performed essentially on the selectively separated water vapor. According to some embodiments, the condensation is continuous.

According to some embodiments, the liquid water droplets 104A-104D are collected in a water collection unit 130. According to some embodiments, water collection unit 130 includes a container 132 configured to collect the water droplets 104A-104D. According to some embodiments, the dimensions of the container 132 are designed to accommodate the desired volume the precipitated liquid water while taking into consideration the liquid water generation rate and/or the delivery rate therefrom. According to some embodiments, the container 132 may be integrally formed within the device 102. According to some embodiments, the container 132 is configured to provide a short-term storage of the generated liquid water. According to some embodiments, the container 132 may be a detachable container, such as but not limited to, in a form of a bottle, a tank, and the like.

According to some embodiments, the container 132 may include an open/close mechanism (not shown), such as a tap, a valve, and the like, configured to retain/release the collected water upon request.

According to some embodiments, water collection unit 130 may include a pump for transferring the precipitated liquid water from container 132 for further use and/or processing.

According to some embodiments, the water collection unit 130 may be in a fluid communication with a storage unit (not depicted), configured for collecting the precipitated liquid water. According to some embodiments, the precipitated liquid water may be further processed, e.g., collected in reservoirs, containers, bottlers, ionized or otherwise enriched with elements/substances, and the like, or any combination thereof.

According to some embodiments, system 100 may include one or more sensors. According to some embodiments, the one or more sensors are designed to detect various operating and/or environment-related parameters, such as ambient temperature, relative humidity, barometric pressure, internal temperature in various compartments of the device, air flow speed to and/or within the device, pump level, pump throughput, pressure gradient, cooling level, vacuum levels, water removal rate, amount of generated water, daylight time, and the like, or any combination thereof.

According to some embodiments, system 100 includes a control unit 140 configured to control and adjust, when necessary, operating parameters of device 102 to increase the efficiency and facilitate the generation of water. According to some embodiments, the control unit 140 may facilitate maintaining the gradient across each of the one or more selective membranes. According to some embodiments, the control unit 140 may control and adjust the temperature difference between the water vapor separation unit 110 and the water precipitation unit 120. According to some embodiments, the control unit 140 may control and adjust the water vapor concentration difference between the water vapor separation unit 110 and the water precipitation unit 120, thereby facilitating the water vapor separation process. According to some embodiments, the control unit 140 may control and adjust the pressure difference (e.g., water vapor pressure difference) between the water vapor separation unit 110 and the water precipitation unit 120. According to some embodiments, the control unit 140 may control and adjust the cooling temperate of the water precipitation unit 120. According to some embodiments, the control unit 140 may control and adjust the ambient air feed rate introduced into the device 102. According to some embodiments, the control unit 140 may control the removal (e.g., rate, time, and the like) of the liquid water collected in water collection unit 130.

According to some embodiments, the control unit 140 may be in a communication with the one or more sensors, to minimize energy consumption and/or increase the efficiency of system 100. According to some embodiments, the control unit 140 automatically adjusts operation parameters such as the ambient air feed rate, to facilitate optimal system operation and water precipitation. According to some embodiments, a user can accept, tailor/adjust or override the operation parameters.

According to some embodiments, system 100 may include a plurality of devices, such as device 102, to facilitate the water generation and/or obtain the optimal operating mode while considering operation parameters, such as temperature, relative air humidity, and the like, or any combination thereof. According to some embodiments, system 100 may be in a communication with a software, such as mobile/computer application, notifying the user regarding operation parameters, such as water precipitation rate, collected water volume, and the like. Alternatively or additionally, the software may allow user input, adjusting/tailoring operation parameters and the like.

According to some embodiments, system 100 is suited for indoor environments and adapted to operate in buildings, apartments, and the like. According to some embodiments, system 100 is suited for outdoor environments, such as but not limited to, field, remote areas, rural settlements, desert, and the like. According to some embodiments, system 100 may be adjusted to function as a self-sustaining and self-powered system. According to some embodiments, system 100 is a portable and/or compact system. According to some embodiments, system 100 is suited for industrial use, such as manufacturing facilities, hospitals, and the like, wherein high water production rate and/or volume are required. Each possibility is a separate embodiment.

Reference is made to FIG. 1B, which illustrates a schematic block diagram of a system 100′ and a device 102′ for precipitating water from atmospheric/ambient air, according to some embodiments. According to some embodiments.

According to some embodiments, the following components depicted in FIG. 1B 100′, 102′, 104A-D, 106A-D, 110′, 120′, 130′, 132′, and 140′ correspond to and may have the same structure and configuration as the previously described components 100, 102, 104A-D, 106A-D, 110, 120, 130, 132, and 140, respectively, in FIG. 1A. According to some embodiments, system 100′ may be identical, similar or different than system 100′ as depicted in FIG. 1A.

According to some embodiments, system 100′ is a dual system. Put differently, in some embodiments, system 100′ may include a first and a second operating stages. According to some embodiments, the first operating stage of system 100′ may include selectively separating and collecting water vapor from the ambient air introduced into water vapor separation unit 110′ (i.e. a first fluid path). According to some embodiments, the first operating stage of system 100′ may include capturing a remnant water vapor in a desiccant unit 150′, as elaborated in greater detail elsewhere herein.

According to some embodiments, the second operating step may include periodically releasing the remnant water vapor captured in desiccant unit 150′ and circulating back the remnant water vapor released from desiccant unit 150′ into water vapor separation unit 110′, as elaborated in greater detail elsewhere herein. According to some embodiments, the second operating stage may include forming an additional fluid path (i.e. a second fluid path) in system 100′, thereby enabling recirculation of the remnant water vapor released from desiccant unit 150′ back into water vapor separation unit 110′, thereby enriching the ambient air introduced into system 100′. According to some embodiments, the recirculation of the remnant water vapor released from desiccant unit 150′ back into water vapor separation unit 110′, may advantageously increase the amount of the collected humidity, which, in turn, increases the liquid water generated by system 100′.

According to some embodiments, the remnant water vapor includes two parts/sources of water vapor. According to some embodiments, the remnant water vapor includes a first part of the remnant water vapor present in the ambient air, wherein the first part of the remnant water vapor may be released from the ambient air by reducing the temperature at sub-zero temperatures. According to some embodiments, the remnant water vapor includes a second part of the remnant water vapor, the second part of the remnant water vapor includes remnant humidity that was not transmitted/separated by water vapor separation unit 110′ during passing therethrough.

According to some embodiments, a fluid exiting water vapor separation unit 110′ may include about 30% or less, about 25% or less, about 20% or less of the remnant water vapor (i.e. the first and the second parts pf the remnant water vapor) therein. Each possibility is a separate embodiment. It may be understood by the skilled in the art, that when the ambient air passing through water vapor separation unit 110, decrease in the amount of humidity therein leads decrease in the water vapor molecules separation rate thereof.

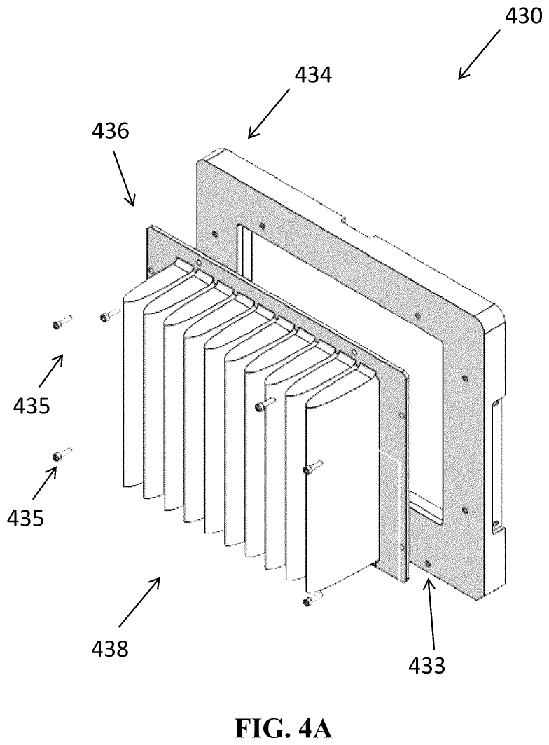

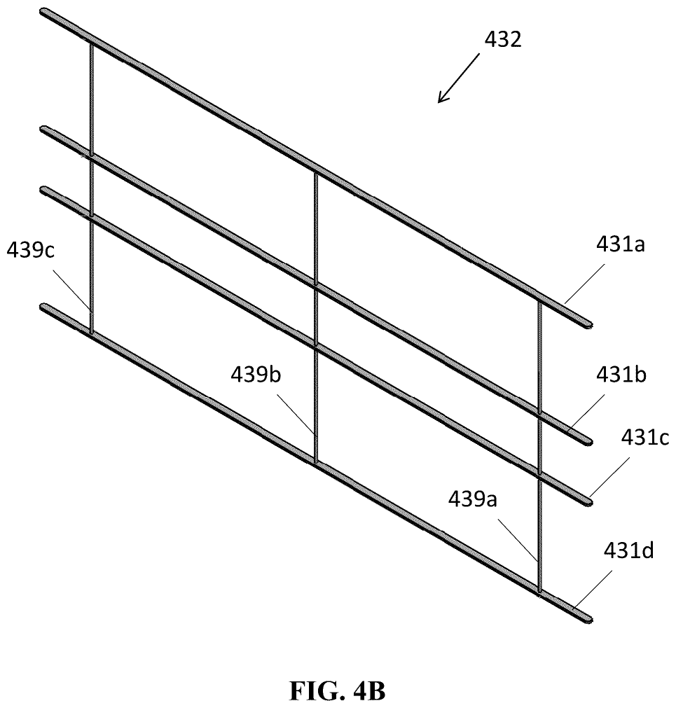

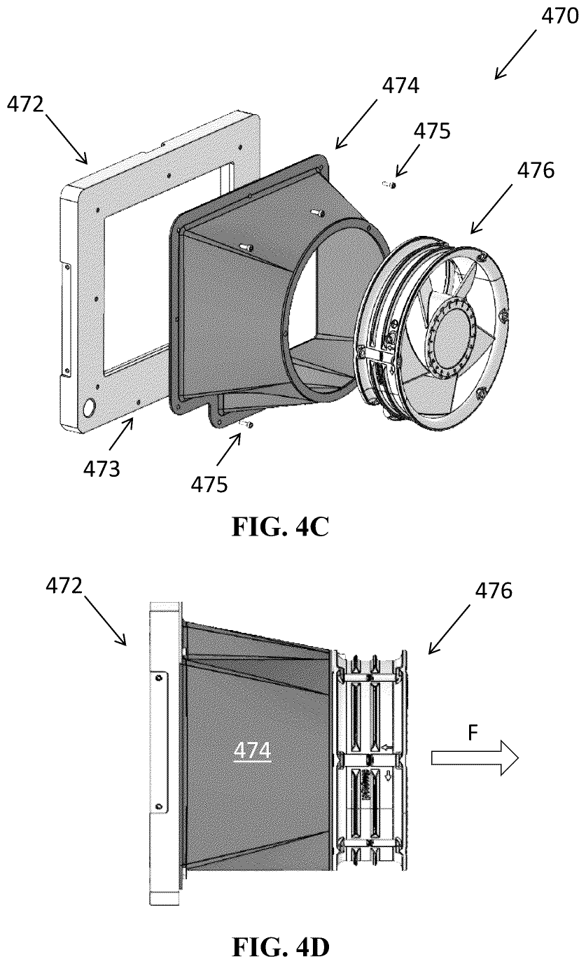

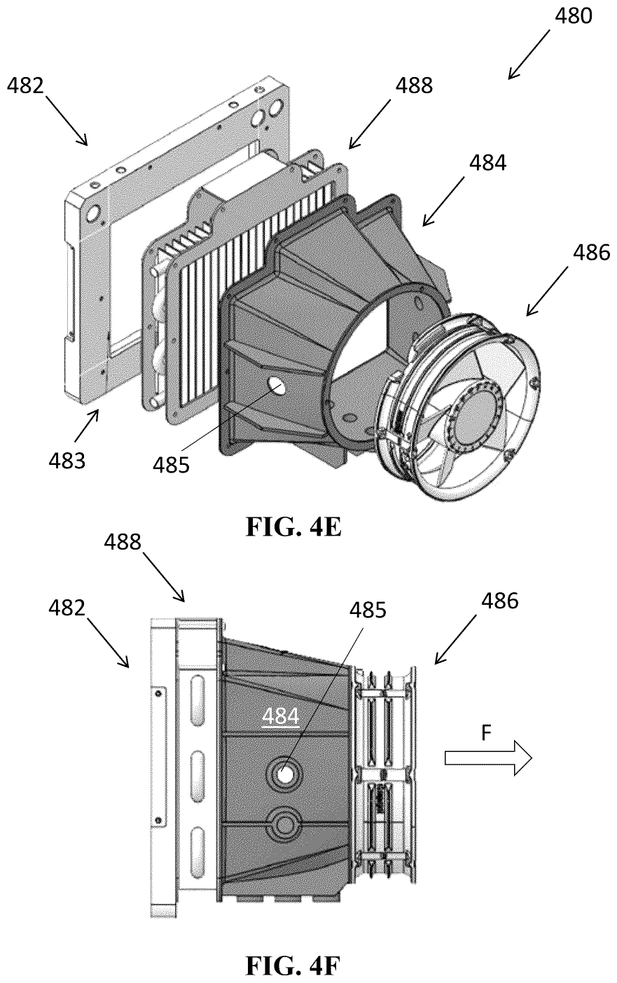

According to some embodiments, the second operating step may include periodically reversing fluid flow in system 100′. Put differently, in some embodiments, system 100′ may be devoid of forming the additional fluid path. According to some embodiments, reversing the fluid flow may be performed by air moving devices of system 100′, e.g., as further depicted in FIGS. 4A-4F.

Consequently, in some embodiments, advantageously reducing the energy consumption of system 100′ (e.g., by cooling substantially the separated water vapor molecules originating from the ambient air and the remnant water vapor released from desiccant unit 150′), and advantageously increasing the amount of the liquid water generated by system 100′. Advantageously, according to some embodiments, system 100′ is configured to utilize the majority of humidity present in the ambient air for generation of liquid water. According to some embodiments, the majority of the humidity may include, among others, about 70% or more, about 75% or more, about 80% or more of humidity present in the ambient air for generation of liquid water.

According to some embodiments, and as depicted in FIG. 1B, system 100′ optionally includes desiccant unit 150′. According to some embodiments, desiccant unit 150′ is in fluid communication with a water precipitation unit 120 and with a water collection unit 130. According to some embodiments, desiccant unit 150′ is in fluid communication with water vapor separation unit 110′. According to some embodiments, desiccant unit 150′ is configured to extract a remnant water vapor (i.e. remnant humidity) from system 100′. According to some embodiments, desiccant unit 150′ is configured to extract the remnant water vapor after passing through water vapor separation unit 110′.

According to some embodiments, and as depicted in FIG. 1B, desiccant unit 150′ may be positioned at an output of water vapor separation unit 110′. According to some embodiments, desiccant unit 150′ may be in fluid communication with an air moving device (e.g., as depicted in FIGS. 4A-4F), as elaborated in greater detail elsewhere herein. According to some embodiments, desiccant unit 150′ may include corresponding cbe positioned such that fluid flow is configured to pass from According to some embodiments, desiccant unit 150′ may be in fluid communication with the air moving device, such that the fluid flow of system 100′ may substantially naturally enter into the desiccant unit 150′, thereby enabling the remnant water vapor extraction while substantially maintaining the air feed flow in the system.

According to some embodiments, desiccant unit 150′ includes a desiccant (not shown) having a high affinity for water vapor molecules, According to some embodiments, the desiccant may be in the form of a zeolite, a molecular sieve, and the like. According to some embodiments, the desiccant may be in liquid and/or solid states.

According to some embodiments, desiccant unit 150′ is configured to operate periodically. According to some embodiments, the desiccant is configured to capture the remnant water vapor therein. According to some embodiments, when the desiccant is substantially full of remnant water vapour captured therein, desiccant unit 150′ may be heated to extract and collect the remnant water vapor therefrom, thereby increasing the liquid water generated by system 100′.

According to some embodiments, desiccant unit 150′ may be detachably attached to system 200′. According to some embodiments, desiccant unit 150′ may be periodically removed to enable removing/collecting the remnant water vapor captured therein. Alternatively, or additionally, in some embodiments, the remnant water vapor captured in desiccant unit 150′ may be periodically released therefrom without removing desiccant unit 150′ from system 100′ and/or from device 102′.

According to some embodiments, desiccant unit 150′ may be, among others, in the form of a wheel. According to some embodiments, desiccant unit 150′ may include two orientations. As a non-limiting example, desiccant unit 150′ may be rotatable between a first and a second orientation or position. According to some embodiments, in the first orientation, desiccant unit 150′ may be in a first operating mode, configured to capture the remnant water vapor. According to some embodiments, in the second orientation, desiccant unit 150′ may be in a second operating mode configured to allow releasing and collecting the captured remnant water vapor therefrom. According to some embodiments, desiccant unit 150′ in the second orientation may be heated, thereby allowing releasing the remnant water vapor therefrom.

According to some embodiments, desiccant unit 150′ may be connected to a heating element (not shown). According to some embodiments, the heating element may be configured to periodically heat at least a portion of desiccant unit 150′, and to periodically cease the heating thereof.

According to some embodiments, the periodic operation of desiccant unit 150′ may be performed at predefined time ranges. According to some embodiments, desiccant unit 150′ may be periodically heated for, among others, 1-5 minutes approximately every 1 hour, approximately every 2 hours, approximately every 3 hours, approximately every 4 hours, approximately every 5 hours, approximately every 6 hours, approximately every 8 hours, approximately every 10 hours, approximately every 15 hours, approximately every 20 hours, and the like. Each possibility is a separate embodiment. According to some embodiments, desiccant unit 150′ may be periodically heated for about 1-5 minutes, for about 2-4 minutes, for about 1-10 minutes, for about 5-10 minutes, and the like. Each possibility is a separate embodiment.

According to some embodiments, a control unit 140′ may be configured to control the periodic operation of desiccant unit 150′. According to some embodiments, control unit 140′ may be configured to control the periodic operation of the heating element of control unit 140′. According to some embodiments, control unit 140′ may control a heating duration, a heating time, a heating frequency, a heating temperature, and the like, or any combination thereof.

According to some embodiments, system 100′ may include one or more sensors. According to some embodiments, the one or more sensors are configured to measure various operating parameters of system 100′ and/or device 102′, and/or environment-related parameters. According to some embodiments, the one or more sensors may include, among others, a weight sensor, a humidity sensor, and the like, to facilitate the periodic operation (i.e. the periodic collection of the remnant water vapor and the period release thereof) of desiccant unit 150′. Alternatively, or additionally, the periodic operation may be based, at least in part of, on calculations configured to predict/calculate the operating parameters, thereby increasing the efficiency thereof.

Reference is now made to FIG. 2A and FIG. 2B, which schematically illustrate a cross-section side view and a cross/section top view, respectively, of a water precipitation system 200 and a device 202, according to some embodiments. According to some embodiments, device 202 includes a water vapor separation unit 210, a water precipitation unit 220, and optionally a water collection unit 230.

According to some embodiments, ambient air (marked as arrows 206A-206E) introduced into the device 202 may be impelled or driven into the water vapor separation unit 210 using any air moving devices (not shown), such as but not limited to, blowers, pumps, fans, and the like. According to some embodiments, the air moving devices may be low power devices, such as fans, capable of introducing large volumes of ambient air at high speeds while minimizing the energy consumption. According to some embodiments, wherein the air moving devices are low power devices, the resistance to air flow of one or more selective membranes 212 positioned within the water vapor separation unit 210 may be essentially equal to or less than about 2 mBar. Alternatively, the resistance to air flow of the one or more selective membranes 212 may vary.

According to some embodiments and as depicted in FIG. 2A, ambient air 206A-206E is essentially vertically introduced into the device 202. Alternatively or additionally, ambient air 206A-206E may be introduced into the device 202 in various directions, such as horizontally.

According to some embodiments, increasing the ambient air flow speed/flow rate leads to increasing the water vapor concentration passing though the one or more selective membranes 212. However, it may be understood by one skilled in the art that when the ambient air flow speed is too high, there is insufficient diffusion time for the water vapor molecules to reach the surface of the one or more selective membranes 212. According to some embodiments, the ambient air flow speed through the water vapor separation unit 210 may be equal to or less than about 10 m/sec. According to some embodiments, the ambient air flow speed through the water vapor separation unit 210 may be at least about 5 m/sec. According to some embodiments, the ambient air flow speed through the water vapor separation unit 210 may be at least about 10 m/sec. According to some embodiments, the ambient air flow speed through the water vapor separation unit 210 may be at least about 15 m/sec. Each possibility is a separate embodiment.

According to some embodiments, the dimensions of the water vapor separation unit 210 are determined based on the operating parameters/requirements of the system 200, such as the required volume and/or rate of liquid water generation, and physical parameters, such as resistance to fluid flow of the plurality of tubes and/or sheets.

According to some embodiments, the water vapor separation unit 210 includes one or more selective membranes 212 configured to selectively separate/transfer water vapor from the ambient air passing therethrough. According to some embodiments, the number and the dimensions of the one or more selective membranes 212 are determined based on the operating parameters/requirements of the system 200.

According to some embodiments and as depicted in FIG. 2, the one or more selective membranes 212 include a tubular configuration. According to some embodiments, the one or more selective membranes 212 include a planar configuration, such as sheets. According to some embodiments, the one or more selective membranes 212 include a combined configuration, e.g., tubular and planar configurations.

According to some embodiments, each of the one or more selective membranes 212 may be essentially parallelly positioned inside the water vapor separation unit 210. According to some embodiments, the water vapor separation unit 210 may be essentially parallelly positioned to the water precipitation unit 220. According to some embodiments, the one or more selective membranes 212 are essentially vertically positioned in the device 202.

According to some embodiments, the one or more selective membranes 212 are designed to receive ambient air 206A-206E flowing therethrough across the longitudinal axis (e.g., parallel to the centerline axis) thereof. As a non-limiting example, the one or more selective membranes 212 having a tubular configuration may be designed allow essentially vertically introduced ambient air flow therethrough (parallel to the centerline axis thereof). Thus, in some embodiments, wherein the water precipitation unit 220 is essentially vertically positioned (e.g., parallel to the longitudinal axis of the one or more selective membranes 212), the water droplets forming in the water precipitation unit 220 are advantageously removed/released therefrom by utilizing gravity, as further elaborated. As another non-limiting example, the one or more selective membranes 212 having a planar configuration may be designed to allow essentially vertically introduced ambient air flow therethrough.

According to some embodiments, the one or more selective membranes 212 are designed to receive ambient air 206A-206E flowing therethrough across a horizontal axis thereof. As a non-limiting example, the one or more selective membranes 212 having a planar configuration may allow essentially horizontally introduced ambient air flow therethrough. In some embodiments, the water precipitation unit 220 may be positioned vertically while the ambient air flow is introduced essentially horizontally through the water vapor separation unit 210 (i.e. essentially horizontally passing through the one or more selective membranes 212).

According to some embodiments, the one or more selective membranes 212 are designed to allow minimizing the resistance to fluid flow therethrough. As a non-limiting example, increasing the diameter and/or the distance between each of the one or more selective membranes 212, leads to decreasing the resistance to fluid flow therethrough.

According to some embodiments, the one or more selective membranes 212 having a resistance to fluid flow therethrough of about 2 mBar or lower.

According to some embodiments, wherein the one or more selective membranes 212 include the tubular configuration, each of the one or more selective membranes 212 having a length to diameter ratio of about at least 100 to 1. According to some embodiments, the diameter of each of the one or more selective membranes 212 is about at least 1 mm. According to some embodiments, the diameter of each of the one or more selective membranes 212 is about at least 1.5 mm. According to some embodiments, the diameter of each of the one or more selective membranes 212 is about at least 2 mm. According to some embodiments, the diameter of each of the one or more selective membranes 212 is about at least 3 mm. According to some embodiments, the diameter of each of the one or more selective membranes 212 is in the approximate range of 3-5 mm. Each possibility is a separate embodiment.

According to some embodiments, wherein the one or more selective membranes 212 include the planar configuration, each of the one or more selective membranes 212 may be advantageously placed at a wide variety of positions across the water vapor separation unit 210. Put differently, the distance between each of the one or more selective membranes 212 may vary. According to some embodiments, the wide variety of positions of each of the one or more selective membranes 212 advantageously allows optimizing the design of the device 202 by tailoring the resistance to fluid flow therethrough. According to some embodiments, the distance between each of the one or more selective membranes 212 having the planar configuration may bein the approximate range of 2-6 mm.

According to some embodiments, the one or more selective membranes 212 form a multi-cavity configuration. According to some embodiments, wherein the one or more selective membranes 212 may be arranged in an efficient and/or close-packed configuration. According to some embodiments, the one or more selective membranes 212 (e.g. having a plurality of sheets and/or a plurality of tubes), may include a multi-cavity configuration, forming a sequential configuration of a water vapor separation unit 210 and a water precipitation unit 220.

According to some embodiments, the one or more selective membranes 212 include or made of a selective membrane that specifically separates and transfers the matters of interest (i.e., water vapors) across opposing surfaces thereof, while essentially preventing/blocking the transport of other species/substances.

According to some embodiments, the one or more selective membranes 212 include or made of an ion-selective membrane that specifically separates and transfers water vapor across each of the one or more selective membranes 212, i.e., from the water vapor separation unit 210 into the water precipitation unit 220. As a non-limiting example, the spontaneous and selective transport of water vapor occurs from a membrane side/surface of each of the one or more selective membranes 212 having a higher concentration of water vapor (i.e., from the water vapor separation unit 210) to an opposing membrane side of each of the one or more selective membranes 212 having a lower concentration of the water vapor (i.e., into the water precipitation unit 220).

According to some embodiments, the selective transport may be driven and maintained by providing a continuous gradient of the water vapor concentration and/or partial pressure and/or temperature on either side of each of the one or more selective membranes 212. According to some embodiments, the liquid water precipitation continuously removes the water vapor molecules, hence continuously decreasing the partial pressure/concentration of the selectively separated water vapor molecules. Consequently, constantly providing a driving force for the selective separation of the liquid water molecules across the one or more selective membranes 212.

According to some embodiments, the one or more selective membranes 212 include or made of carbon-based membranes, such as but not limited to graphene and its derivatives, such as graphene oxide, carbon nano tubes (CNTs), and the like, or any combination thereof. According to some embodiments, the one or more selective membranes 212 include or made of 2-dimensional material membranes (2DMMs). Each possibility is a separate embodiment.

According to some embodiments, the one or more selective membranes 212 include or made of a porous membrane. According to some embodiments, the one or more selective membranes 212 include or made of a laminar membrane. According to some embodiments, the one or more selective membranes 212 include or made of semi-porous membrane. According to some embodiments, the one or more selective membranes 212 include or made of a ceramic membrane. Each possibility is a separate embodiment.

According to some embodiments, one or more selective membranes 212 may include or be made of a proton exchange membrane. According to some embodiments, the proton exchange membrane may have sulphonic groups attached thereto. According to some embodiments one or more selective membranes 212 may be made of or include any type of a proton exchange membrane, wherein the exchange membrane is substantially based on a general Nafion copolymer structure and sulphonic groups attached thereto. According to some embodiments, one or more selective membranes 212 may include or be made of a membrane impregnated with Nafion, or any type of substantially similar materials. According to some embodiments, one or more selective membranes 212 may be made of or include one or more of: Aquivion, Flemion and Perfluorosulfonic acid (PFSA) ion exchange membrane, such as PFSA D50/125-U.

According to some embodiments, the one or more selective membranes 212 include or made of a non-porous membrane. According to some embodiments, the one or more selective membranes 212 include or made of Nafion, or Nafion composites. According to some embodiments, the one or more selective membranes 212 include or made of non-porous membranes impregnated with Nafion solution. According to some embodiments, the one or more selective membranes 212 include or made of Nafion tubes, Flemion tubes, and the like. According to some embodiments, the one or more selective membranes 212 include or made of Nafion sheets. According to some embodiments, the one or more selective membranes 212 include or made of Nafion, Flemion, Aquivion. and the like, having various configurations (e.g., combination of tubes and sheets).

Nafion (interchangeable with Nafion™) is a copolymer of perfluoroo-3,6-dioza-4-methyl-7octene-sulfonic acid and Teflon (polytetrafluoroethylene). Specifically, Nafion contains a Teflon backbone with occasional side chains added of another fluorocarbon. The fluorocarbon side chain terminates in a sulfonic acid (—SO3H). Each sulphonic group absorbs up to 13 water molecules, thereby allowing efficient water molecules separation. Further, with the exception of the sulfonic acid groups, Nafion is made of a fluorocarbon polymer. Like most fluoropolymers, it is chemically inert (extremely resistant to chemical attack).

According to some embodiments, Nafion membrane is advantageously utilized in the form of tubes (wherein the one or more selective membranes 212 include a plurality of tubes). According to some embodiments, the disclosed herein tubular configuration of

Nafion may increase the mechanical strength and stability thereof. According to some embodiments, the configuration of the plurality of tubes significantly increases the surface area to volume ratio thereof, rendering the water vapor separation process highly efficient. According to some embodiments, in a scenario wherein a first system includes a plurality of parallel sheet membranes and a second system includes a plurality of tubular membranes, the efficiency of water vapor separation/transport is higher in the second system, due to the following reasons: (i) surface to volume ratio is two times greater in the second system (i.e. contact area between the one or more selective membranes and the ambient air passing therethrough is 2 times greater) (ii) the average diffusion length required for a water vapor molecule to travel in order to reach a selective membrane is 1.5 times shorter in the second system. Put differently, when comparing two systems with a given volume of an ambient air introduced therein, the water vapor separation/transport efficiency of the second system is 3 times greater than that of the first system, due to the utilization of the tubular configuration of the selective membrane.

Further, according to some embodiments, the abovementioned reasons affecting the water vapor separation/transport advantageously allow calculating and predicting the water generation volume and rate as a function of the surface area of the selective membrane, ambient air, time, temperature and humidity.

According to some embodiments, the one or more selective membranes 212 advantageously having high water permeability, selectivity, and high impermeability to other various gases and/or contaminants. As a non-limiting example, the one or more selective membranes 212 (e.g., made of Nafion) will essentially/substantially not transfer bacteria, viruses, and any other air-borne contaminants, from the water vapor separation unit 210 into the water precipitation unit 220.

According to some embodiments, the thickness of the one or more selective membranes 212 may be less than about 500 microns. According to some embodiments, the thickness of the one or more selective membranes 212 may be less than about 250 microns. According to some embodiments, the thickness of the one or more selective membranes 212 may be less than about 200 microns. According to some embodiments, the thickness of the one or more selective membranes 212 may be less than about 100 microns. According to some embodiments, the thickness of the one or more selective membranes 212 may be less than about 60 microns. According to some embodiments, the thickness of the one or more selective membranes 212 may be less than about 30 microns. According to some embodiments, the thickness of the one or more selective membranes 212 may be in the range of about 0.5-100 microns. Each possibility is a separate embodiment.

According to some embodiments, the one or more selective membranes 212 may include a planar configuration, such as sheets. As a non-limiting example, the one or more selective membranes 212 may include Nafion sheets. Scenarios wherein it may be beneficial to implement Nafion sheets include the commercial availability of a wide variety Nafion sheet sizes, allowing the design of the disclosed herein systems (e.g., system 200) with various operating parameters.

According to some embodiments, Nafion membrane is advantageously utilized in the form of sheets (wherein the one or more selective membranes 212 include one or more sheets). According to some embodiments, the commercial availability of Nafion sheets advantageously allows designing the system 200 at a wide variety of sizes, having the optimal configuration for the desired outcome (e.g., volume and/or rate of liquid water). According to some embodiments, the one or more sheets are essentially parallel. According to some embodiments, the one or more sheets are arranged to be essentially vertically positioned having an inner space, thereby allowing a fluid flow therebetween.

According to some embodiments, the high commercial availability of Nafion sheets having various sizes advantageously allows a wide variety of system designs, thereby decreasing the resistance to fluid flow therethrough. According to some embodiments, the number of the one or more sheets depends, among others, on the desired dimensions of the system 200, the desired volume of the precipitated liquid water, air flow dynamics, resistance, fluid flow speed and volume, complexity level, packaging, production costs, and the like or any combination thereof. According to some embodiments, the one or more sheets include, among others, two sheets.

According to some embodiments, each two of the selective membranes may form a double membrane cavity. According to some embodiments, the width of the double membrane cavity may be in the approximate range of 3-5 mm (e.g., as marked by a pair of arrows 225). According to some embodiments, the corresponding width of a cooling cavity (between each of the double membrane cavities having the planar configuration), as further detailed herein, is in the approximate range of 3-10 mm. According to some embodiments, the corresponding width of the cooling cavity is in the approximate range of 3-8 mm. Each possibility is a separate embodiment.

According to some embodiments, decreasing the thickness of the one or more selective membranes 212 leads to increasing the efficiency of system 200. According to some embodiments, the influence of the thickness of the one or more selective membranes 212 on the separation/transmission rate of the water vapor molecules per unit area is of a secondary degree. According to some embodiments, the selective separation process of the water vapor includes three main steps: (i) attaching the water vapor to the surface of the one or more selective membranes 212, (ii) diffusing of the water vapor molecules therethrough (pervaporation), and (iii) dissociating/releasing the water vapor molecules from the other surface/side of the one or more selective membranes 212. In some embodiments, the first and the third steps have the greatest effect on the efficiency of the selective separation/transfer process. According to some embodiments, introducing minor air perturbations/deflections (i.e., perturbations having minor effects on the resistance to fluid flow) leads to directing the ambient air flow towards the surface of the plurality of tubes 212, thereby increasing the water vapor transport rate by increasing the rate of the aforementioned first step.

According to some embodiments, the one or more selective membranes 212 require no or minimal supporting means to facilitate the mechanical stability thereof. As a non-limiting example, the one or more selective membranes 212 having the tubular configuration advantageously require no or minimal supporting means for increasing the mechanical stability.

According to some embodiments, the selectively separated/transferred water vapor molecules travel/pass into the water precipitation unit 220. According to some embodiments, the water precipitation unit 220 includes a plurality of cooling elements 222 configured for precipitating the water vapor into liquid water droplets. According to some embodiments, the plurality of cooling elements 222 are configured to provide essentially parallel cooling to one or more selective membranes 212, thereby condensing the selectively separated water vapor into liquid water droplets.

According to some embodiments, the plurality of cooling elements 222 is in the form of a cavity, tube, conduit, channel, column, and the like. According to some embodiments, the cross-section of the cavity may be in a form of a curved shaped structure, such as circular, elliptic, D-shaped, or any other curvature. According to some embodiments, the cross-section of the cavity may be rectangular, quadratic, hexagonal, polygon, polygon-like, and the like, or any combination thereof.

According to some embodiments, the plurality of cooling elements 222 is configured to allow fast release of the liquid water droplets forming on a cooling surface 224 thereof. According to some embodiments, the plurality of cooling elements 222 are essentially vertically positioned, thus advantageously utilizing gravity to facilitate the release of the liquid water droplets therefrom.

According to some embodiments the cooling surface 224 includes or made of heat conducting materials. According to some embodiments the cooling surface 224 includes an outer super hydrophobic layer, coating or surface, to facilitate releasing the water vapor droplets forming thereon.

According to some embodiments, the cooling surface 224 includes one or more islands (not shown) of highly hydrophilic materials/coatings. According to some embodiments, the one or more islands advantageously increase the number of liquid water nucleation sites, which, in turn, increases the nucleation rate and promotes the precipitation of liquid water droplets. According to some embodiments, the size (e.g., length, diameter, and the like) of each of the one or more islands is about 0.5 mm or less. According to some embodiments, the distance between each of the one or more islands is about at least 3 mm.

According to some embodiments, the cooling surface 224 includes a plurality of protruding and/or intruding elements (not depicted), such as but not limited to, pins, needles, cone-like shaped structures, and the like, or any combination thereof. According to some embodiments, the distance between a tip of each of the plurality of protruding elements to the surface of the one or more selective membranes 212 is in the approximate range of 0.5-2.5 mm. According to some embodiments, the plurality of protruding and/or intruding elements are configured for enhancing and facilitating nucleation as well as increasing the surface area of the cooling surface 224, thereby facilitating the nucleation and hence the formation of the liquid water droplets. According to some embodiments, the plurality of protruding elements is configured to reduce the diffusion time of the water vapor molecules from the one or more selective membranes 212 to the cooling surface 224, thereby facilitating the nucleation process.

According to some embodiments and as depicted in FIG. 2A and FIG. 2B, the arrangement of the plurality of cooling elements 222 corresponds with the arrangement of the one or more cooling elements 212. According to some embodiments, each of the plurality of cooling elements 222 is positioned consecutively and in proximity to each of the one or more selective membranes 212, thereby minimizing the diffusion time while easily releasing the precipitated liquid water droplets therefrom. As a non-limiting example, each of the plurality of cooling elements 222 may be essentially or partially concentric to each of the one or more selective membranes 212. According to some embodiments, the plurality of cooling elements 222 provides concentric cooling to the selectively separated water vapor in the water precipitation unit 220, thereby condensing the water vapor into liquid water droplets.

According to some embodiments, the plurality of cooling elements 222 is arranged in a periodic pattern (e.g., in a lattice configuration). According to some embodiments and as depicted in FIG. 2B, the plurality of cooling elements is arranged in a close-packed configuration, such as a hexagonal/“honeycomb” configuration, advantageously minimizing voids therebetween. According to some embodiments, the hexagonal configuration is expressed as an ABAB stacking sequence. Put differently, an “A” layer is occupied by the plurality of tubes, and a “B” layer is occupied by the plurality of cooling elements (or vice versa), thus forming the hexagonal configuration. Alternatively, in some embodiments the plurality of cooling elements 222 is parallelly or otherwise arranged. It may be understood by one skilled in the art that the number of the plurality of cooling elements 222 may vary. According to some embodiments, the number of the plurality of cooling elements 222 depends, among others, on the number and the configuration of the one or more selective membranes 212, dimensions of the device 202 and the system 200, the desired outcome (e.g., water generation rate, volume, etc.), etc.

According to some embodiments, the diameter (marked by a pair of arrows 229) of the cavity 226 is about 3 mm. According to some embodiments, the diameter of the cavity 226 is about 3.5 mm. According to some embodiments, the diameter of the cavity 226 is about 2.5 mm. According to some embodiments, the diameter of the cavity 226 is the approximate range of 2-5 mm. Each possibility is a separate embodiment.

According to some embodiments and as depicted in FIG. 2, the distance between the cooling surface 224 and an outer surface/circumference of each of the one or more selective membranes 212 (as marked by a double arrow 227) is about 3 mm. According to some embodiments, the distance between the cooling surface 224 and the outer surface/circumference of each of the one or more selective membranes 212 is about 3.5 mm. According to some embodiments, the distance between the cooling surface 224 and the outer surface/circumference of each of the one or more selective membranes 212 is in the approximate range of 2.5-4 mm. According to some embodiments, the distance between the cooling surface 224 and the outer surface/circumference of each of the one or more selective membranes 212 is in the approximate range of 3-4 mm. According to some embodiments, the distance between the cooling surface 224 and the outer surface/circumference of each of the one or more selective membranes 212 is less than about 6 mm. Each possibility is a separate embodiment.

According to some embodiments, the plurality of cooling elements 222 includes a cooling fluid in a cavity 226 thereof. According to some embodiment, the cooling fluid includes a gas, such as but not limited to, nitrogen. According to some embodiments, the cooling fluid includes a gas mixture. According to some embodiments, the cooling fluid may include a refrigerant fluid. According to some embodiments, the cooling fluid temperature is about 0° C. According to some embodiments, the cooling fluid temperature is lower than about 0° C. to some embodiments, the cooling fluid temperature is in the approximate range of −5-0° C. Each possibility is a separate embodiment.

According to some embodiments, the cooling fluid may be circulated through a close-loop system (as marked by arrows 228A and 228B). According to some embodiments, the cooling fluid is continuously circulated. Alternatively, or additionally, the cooling fluid may be introduced into device 202 by a pulsed fluid flow. According to some embodiments, the cooling fluid may be stored in a chamber/reservoir (not shown). According to some embodiments, the chamber/reservoir of the cooling fluid is insulated. According to some embodiments, the chamber/reservoir is configured to cool the cooling fluid, by, for example, compressing.

According to some embodiments and as depicted in FIG. 2, the system 200 optionally includes a low power air moving device 205. As a non-limiting example, the low power air moving device 205 is a fan, a blower, and the like, or any combination thereof. According to some embodiments, the low power air moving device 205 facilitates the removal of essentially dried air (i.e., stripped of water vapor, marked as arrows 208A-208D) from device 202. According to some embodiments, the low power air moving device 205 may facilitate introducing the ambient air into the device 202. According to some embodiments, air moving device 205 may include an aerodynamic structure, e.g. as depicted in FIGS. 4A-4F.

According to some embodiments, the device 202 includes a water collection unit 230. According to some embodiments, the collection unit 230 is positioned at least partially beneath the water precipitation unit 220. According to some embodiments, the water collection unit 230 includes a container 232, configured to collect the liquid water droplets. According to some embodiments, the water collection unit 230 includes a pump 234 dictating an open/close state of the water collection unit 230. Put differently, in the open state, the liquid water is further transferred (e.g., into a different container, bottles, and the like), while in the close state the liquid water is retained in the container 232. According to some embodiments, the pump 234 may adjust the supply amount of the liquid water per unit time.

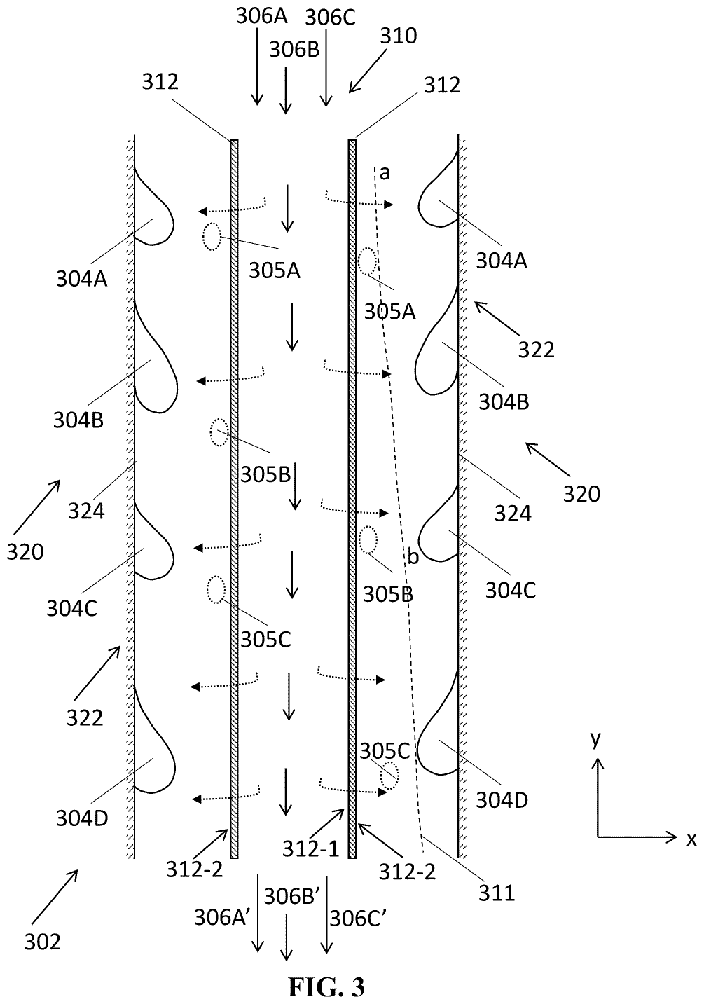

Reference is now made to FIG. 3, which schematically illustrates a partial cross-sectional side view of a device 302 for precipitating water from ambient air, according to some embodiments. According to some embodiments, the partial cross-sectional side view of device 302 may be identical, similar, or different from a cross-sectional side view of the previously disclosed device 202 and/or device 102. It may be understood by one skilled in the art that the depicted features in FIG. 3, including their lateral and longitudinal dimensions, lack of correspondence to the actual proportions thereof.

According to some embodiments, the device 302 includes a water vapor separation unit 310, having one or more selective membranes 312 configured to selectively separate/transfer water vapor molecules from the ambient air. According to some embodiments, the device 302 includes a water precipitation unit 320, having a plurality of cooling elements 322 configured to precipitate liquid water droplets 304A-304D. According to some embodiments, the device 302 may include one or more additional units (not shown), such as water collection unit, processing unit, ionizing unit, and the like, or any combination thereof.

According to some embodiments and as depicted in FIG. 3, ambient air (marked by arrows 306A-306C) is introduced into a water vapor separation unit 310. As a non-limiting example, the temperature of the ambient air 306A-306C may be about 30° C., and the relative humidity thereof is about 67% (i.e. the water vapor pressure of the ambient air 306A-306C is about 28 mBar). It may be understood by one skilled in the art that the temperature and the relative humidity level of the ambient air 306A-306C may vary (such as, but not limited to, temperature between about 0-55° C., and relative humidity between about 10-95%).

According to some embodiments, and in operation, cooling is initiated in the water precipitation unit 320. In particular, the temperature of a cooling surface 324 of the plurality of cooling elements 322 is decreased, initiating the precipitation of the liquid water droplets 304A-304D thereon. As a non-limiting example, the temperature of the cooling surface may be in the approximate range of 0-3° C. As a non-limiting example, the temperature of the cooling surface may be about 0.3° C. According to some embodiments, introduction of the ambient air 306A-306C into the water vapor separation unit 310 increases the water vapor concentration near/on a first surface/side 312-1 of the one or more selective membranes 312, while the precipitation of the liquid water droplets 304A-304D decreases the concentration of selectively separated water vapor molecules 305A-305C near/on a second (opposing) surface/side 312-2 of the one or more selective membranes 312. Put differently, the precipitation of the liquid wated droplets 304A-304D in the water precipitation unit 320 increases the water vapor concentration and/or pressure gradient across the one or more selective membranes 312, thereby driving the precipitation process.

According to some embodiments and as depicted in FIG. 3, ambient air flow through the one or more selective membranes 312 is vertical (i.e. parallel to the depicted y-axis). Alternatively, or additionally, in some embodiments, the ambient air flow through the one or more selective membranes 312 may be horizontal (i.e. parallel to the depicted x-axis). As a non-limiting example, the one or more selective membranes 312 may include a tubular configuration, configured to allow essentially vertically flowing ambient air therethrough, while the water precipitation unit 320 is essentially parallelly positioned to the depicted y-axis. As another non-limiting example, the one or more selective membranes 312 may include a planar configuration (e.g., sheets), configured to allow essentially horizontally and/or vertically flowing ambient air therethrough, while the water precipitation unit 320 is essentially parallelly positioned to the depicted y-axis.

According to some embodiments, in operation, the ambient air flow though the water vapor separation unit 310 reaches steady state conditions. According to some embodiments, the steady state conditions include decreasing the temperature and decreasing the relative humidity of the ambient air 306A-306C introduced into the device 302 while flowing therethrough. As a non-limiting example, wherein the temperature of the ambient air 306A-306C is about 30° C., and wherein the relative humidity thereof is about 67%, the temperature of the ambient air 306A-306C flowing through the one or more selective membranes 312 may be decreased along a path flow there though by about 4-6° C. upon exiting therefrom. According to some embodiments, a fluid 306A′-306C′ exiting the water vapor separation unit 310 may include relative humidity of about 25% (i.e. water vapor pressure of about 8 mBar). According to some embodiments, the decrease in the relative humidity (e.g. from about 67% to about 25%) occurs due to the water vapor concentration and/or pressure gradient across the one or more selective membranes 312. According to some embodiments, the path length of the ambient air 306A-306C along the water vapor separation unit 310 may be, among others, about 30 cm. According to some embodiments, ambient air 306A-306C flow speed may be, among others, about 10 m/sec.

It may be understood by one skilled in the art that the temperature and the humidity level of the ambient air flowing through the one or more selective membranes 312, as well as the ambient air flow speed and the path length may vary.

According to some embodiments, the device 302 may include one or more sensors configured to measure the ambient air flow speed along the water vapor separation unit 310. According to some embodiments, the device 302 may include a control unit configured to control and adjust operating parameters. According to some embodiments, the ambient air flow speed may be adjusted (increased/decreased) to facilitate liquid water generation. According to some embodiments, the ambient air flow speed adjustment may be based, among others, the ambient (i.e. initial) temperature of the ambient air 306A-306C, the initial/ambient humidity conditions, and the like, or any combination thereof.

According to some embodiments, the one or more selective membranes 312 selectively separate/transfer water vapor molecules from the ambient air 306A-306C passing through the water vapor separation unit 310 into the water precipitation unit 320. According to some embodiments, water vapor molecules may attach to the first surface/side 312-1 of the one or more selective membranes 312, diffuse therethrough, and dissociate from the second (opposing) surface/side 312-2 (i.e. as schematically marked by dotted curved arrows in FIG. 3). According to some embodiments, the selective water vapor separation is driven and maintained by the water vapor concentration gradient and/or water vapor pressure gradient across the one or more selective membranes 312. According to some embodiments, the selectively separated water vapor molecules (marked by 305A-305C) in the water precipitation unit 320 may diffuse or otherwise reach the cooling surface 324. According to some embodiments, the temperature of the selectively separated water vapor molecules 305A-305C may rapidly decrease upon reaching the cooling surface 324. According to some embodiments, the temperature of the selectively separated water vapor molecules 305A-305C in the vicinity of the second surface/side 321-2 of the one or more selective membranes 312 may be maintained as close as possible to the temperature of the ambient air flow, to facilitate the transfer of the water vapor molecules 305A-305C.

According to some embodiments, a dew point temperature profile 311 schematically demonstrates a dew point temperature as a function of a distance from the second surface/side 312-2 of the one or more selective membranes 312 to the cooling surface 324. According to some embodiments and as schematically depicted in FIG. 3, the dew point temperature profile 311 gradually decreases along the water vapor precipitation unit 320. According to some embodiments, the highest dew point temperature is present in the vicinity to the ambient air introduction region, which is then decreases along the water precipitation unit 320 (i.e. parallel to the path length of the ambient air 306A-306C flowing through the water vapor separation unit 310). This can be explained as follows. The ambient air introduced into the water vapor separation unit flows there though while water vapor molecules are simultaneously and selectively separated therefrom. The selective separation of the water vapor from the ambient air decreases the relative humidity along the ambient air path flow, decreasing the dew point temperature. Hence, the selectively separated water vapor molecules diffuse (or otherwise reach) closer to the cooling surface (i.e. undergo further cooling) in order to precipitate out and generate liquid water, as schematically depicted by the dew point temperature 311. As a non-limiting example, wherein the temperature of the ambient air 306A-306C is about 30° C., and wherein the relative humidity thereof is about 67%, a dew point temperature at a first region marked by “a” may be about 23° C., and decrease to about 15° C. upon reaching a second region marked by “b”.

According to some embodiments, it may be beneficial to maintain the dew point temperature in the vicinity to the cooling surface 324 (i.e. distancing the dew point away from the second surface/side 312-2), to facilitate water vapor molecules separation and transfer therethrough.

According to some embodiments, the ambient air flow path may be increased by increasing the length of the one or more selective membranes 312, such as but not limited to, increasing the length of the plurality of sheets and/or of the plurality tubes.

According to some embodiments, the precipitation of the liquid water droplets 304-A-304D after passing the dew point temperature maintains and/or increases the water vapor gradient, hence facilitating separating/transferring additional water vapor molecules though the one or more selective membranes 312 and into the water precipitation unit 320. It thus may be understood by one skilled in the art that the efficiency of the disclosed herein water precipitation methods may be limited, among others, by the generation and the release rates of the water droplets 304A-304D from the cooling surface 324.

According to some embodiments, the cooling surface 324 includes an outer super hydrophobic layer, coating or surface, to facilitate releasing the water vapor droplets forming thereon. According to some embodiments, the cooling surface 324 includes one or more islands (not shown) of highly hydrophilic materials/coatings. According to some embodiments, the one or more islands advantageously increase the number of liquid water nucleation sites, which, in turn, increases the nucleation rate and promotes the precipitation of liquid water droplets.

According to some embodiments, the device 302 advantageously cools essentially the selectively separated water vapor 305A-305C instead of cooling the entire ambient air 306A-306C content for generating liquid water, thus reducing the energy required for the liquid water precipitation.

Reference is made to FIG. 4A. which schematically illustrates a perspective side view of an air moving device having an assemblable aerodynamic structure 430, prior to assembling thereof. According to some embodiments, aerodynamic structure 430 may by in fluid communication with system 100 and/or system 100′ depicted in FIGS. 1A-B, and the like. According to some embodiments, air moving device 205 depicted in FIG. 2A may include or be in fluid communication with aerodynamic structure 430.

According to some embodiments, aerodynamic structure 430 may be positioned, among others, at an entrance and/or at an output of water vapor separation unit 110.

According to some embodiments, aerodynamic structure 430 is configured to facilitate and enhance the ambient air flow or any other fluid type into an AWG system (e.g., system 100, system 100′, system 200, and the like). According to some embodiments, aerodynamic structure 430 is configured to increase a ratio of the ambient air flow to power consumption, thereby increasing the efficiency of the system. Put differently, in some embodiments, aerodynamic structure 430 may facilitate increasing the air flow feed, thereby providing an increased amount of water vapor per time into the water vapor separation unit thereof.

According to some embodiments, aerodynamic structure 430 is configured to reduce the resistance to the ambient air flow through the water vapor separation unit of the system. According to some embodiments, aerodynamic structure 430 is configured to increase the fluid capacity, e.g., the air capacity flowing through water vapor separation unit. According to some embodiments, aerodynamic structure 430 is configured to facilitate guiding the ambient air into cavities between the one or more selective membranes of the water vapor selectivity member of the water vapor separation unit. According to some embodiments, aerodynamic structure 430 is configured to reduce resistance to the fluid flow (e.g., the ambient air flow) passing through cavities between the plurality of selective sheets and/or the plurality of selective tubes of the one or more selective membranes.

According to some embodiments, aerodynamic structure 430 includes a first frame 434, a second frame 436 and a plurality of fins 438. According to some embodiments, first frame 434 may be attached to the water vapor separation unit. According to some embodiments, first frame 434 may be detachably attached to the water vapor separation unit. According to some embodiments, first frame 434 may be integrally formed within the water vapor separation unit. According to some embodiments, first frame 434 may be attached to a water precipitation unit of the system.

According to some embodiments, second frame 436 is configured to retain/attach plurality of fins 438 thereto to facilitate installing thereof. According to some embodiments, second frame 436 is attached to first frame 434. According to some embodiments, a plurality of bolts 435 may be inserted into a corresponding plurality of slots 433 to allow attaching/assembling second frame 436 to first frame 434. According to some embodiments, plurality of bolts 435 may refer to any suitable type of connecting means and/or connecting mechanism, such as, but not limited to, bolts, screws, pins. and the like, or any combination thereof. Alternatively, in some embodiments, first frame 434 and second frame 436 may be integrally formed.

According to some embodiments, plurality of fins 438 of aerodynamic structure 430 is configured to facilitate and/or enhance fluid flow, such as the ambient air flow through the water vapor separation unit. According to some embodiments, plurality of fins 438 is configured to facilitate guiding the ambient air (or any other type of an external air source) into the cavities of the plurality of selective tubes and/or sheets of the one or more selective membranes.

According to some embodiments, plurality of fins 438 may have a curved structure, as schematically depicted in FIG. 4A. According to some embodiments, the curved structure of plurality of fins 438 is configured to facilitate the aerodynamic characteristics thereof. According to some embodiments, the curved structure may facilitate the aerodynamic characteristics by minimizing and/or preventing air flow separation at high flow rates.

According to some embodiments, a desiccant unit (e.g. desiccant unit 150′ of FIG. 1B) may be in fluid communication with aerodynamic structure 430. According to some embodiments, the desiccant unit and aerodynamic structure 430 may have identical, similar or corresponding plurality of fins 438. Consequently, in some embodiments, fluid flow exiting the desiccant unit and entering aerodynamic structure 430 may be substantially devoid of disturbance. Put differently, in some embodiments, the fluid flow exiting the desiccant unit and entering aerodynamic structure 430 may substantially continuously flow from the water vapor separation unit and into the desiccant unit. In some embodiments, the fluid flow may substantially naturally enter the desiccant unit, thereby enabling the remnant water vapor extraction while substantially maintaining the air feed flow in the system. According to some embodiments, without wishing to be bound to any theory or mechanism, the fluid flow may substantially naturally diffuse into the desiccant unit, thereby enabling the remnant water vapor extraction while substantially maintaining the air feed flow in the system.

According to some embodiments, and as depicted in FIG. 4B, aerodynamic structure 430 may include a frame 432. According to some embodiments, frame 432 is configured to retain the position of the one or more selective membranes of the vapor separation unit, thereby minimizing/preventing displacing thereof. According to some embodiments, frame 432 is configured to prevent joining and/or collapsing the one or more selective membranes due to the fast flow therethrough, thereby facilitating the aerodynamic characteristics thereof.

According to some embodiments, and as depicted on FIG. 4B, frame 432 includes a plurality of horizontal plates 431a-431d and a plurality of vertical plates 439a-439c configured to be attached to the one or more selective membranes. According to some embodiments, frame 432 may include various geometric forms configured to retain the position of the one or more selective membranes. According to some embodiments, frame 432 may be made of or include one or more metals, one or more ceramic materials, one or more polymers, or any combination thereof.

Reference is made to FIGS. 4C-4D, which schematically illustrate a perspective side view of an air moving device having an assemblable aerodynamic structure 470 prior to assembling thereof, and an assembled side view thereof. According to some embodiments, aerodynamic structure 470 may by in fluid communication with system 100 and/or system 100′ depicted in FIGS. 1A-B, and the like. According to some embodiments, air moving device 205 depicted in FIG. 2A may include or be in fluid communication with aerodynamic structure 470.

According to some embodiments, aerodynamic structure 470 may be positioned, among others, at an entrance and/or at an output of any unit of the system, such as but not limited to, the water vapor separation unit thereof and/or the water precipitation unit.

According to some embodiments, aerodynamic structure 470 is configured to reduce the resistance to fluid flow therethrough, thereby increasing fluid flow feed into and through the system. According to some embodiments, aerodynamic structure 470 may be configured to increase the ratio of fluid flow to power consumption, thereby increasing the efficiency of the system.

According to some embodiments, and as depicted in FIGS. 4C-4D, aerodynamic structure 470 includes a fluid exit bracket 472, a funnel 474, and a fan 476. According to some embodiments, a plurality of screws 475 may be inserted into a corresponding plurality of slots 473 to attach funnel 474 to fluid exit bracket 472. According to some embodiments, plurality of screws 475 may refer to any type of attaching means and/or attaching mechanism, such as, screws, bolts, pins, a snap-fit mechanism, and the like. According to some embodiments, plurality of screws 475 may include a plurality of teeth (e.g., mounted on air exit bracket 472, or mounted on funnel 474) and corresponding plurality of slots 473, thereby allowing coupling air exit bracket 472 with funnel 474. According to some embodiments, the plurality of teeth may be asymmetrically positioned. According to some embodiments, the plurality of teeth may differ in, among others, size, structure, orientation, and the like, such that of the plurality of teeth may be inserted into each of the plurality of slots 473, allowing coupling at a preferred orientation only.

According to some embodiments, and as schematically depicted in FIG. 4D, a fluid flow direction through aerodynamic structure 470 is marked by an arrow F. According to some embodiments, fluid flowing therethrough flows from air exit bracket 472 and into fan 476. According to some embodiments, the fluid flow direction through aerodynamic structure 470 may be reversable, thereby allowing recirculation of the flow through the system. According to some embodiments, the fluid flow direction may be reversed to release the remnant water vapor captured in a desiccant unit. According to some embodiments, the remnant water vapor releasing from the desiccant unit may be recirculated by reversing the fluid flow direction through aerodynamic structure 470. Thereby, in some embodiments, enriching with humidity the ambient air introduced into the water vapor separation unit, resulting in increasing the liquid water generation in the system.

Reference is made to FIGS. 4E-4F, which show a schematic illustration of a perspective side view of an assemblable aerodynamic structure 480 prior to assembling thereof, and of a side view after assembling thereof, according to some embodiments. According to some embodiments, aerodynamic structure 480 may be substantially similar to aerodynamic structure 470 of FIGS. 4C-4D.

According to some embodiments, aerodynamic structure 480 may be positioned at an entrance and/or output of any unit type of the disclosed system. According to some embodiments, aerodynamic structure 480 is configured to reduce the resistance to fluid flow therethrough, thereby increasing fluid flow rate. According to some embodiments, aerodynamic structure 480 may be configured to increase the ratio of fluid flow to power consumption, thereby increasing the efficiency of the system. According to some embodiments, aerodynamic structure 480 may be positioned, among others, at the entrance and/or output of the water precipitation unit.

According to some embodiments, and as depicted in FIGS. 4E-4F, aerodynamic structure 480 includes a fluid exit bracket 482, a funnel 484, a fan 486, and a condenser 488. According to some embodiments, a plurality of screws (not shown) may be inserted into a corresponding plurality of slots 483 to attach funnel 484 to fluid exit bracket 482. According to some embodiments, the plurality of screws may refer to any type of attaching means and/or attaching mechanism, such as, screws, bolts, pins. teeth, a snap-fit mechanism, and the like. According to some embodiments, the plurality of screws may include a plurality of teeth (e.g., mounted on air exit bracket 482, or mounted on funnel 484) and corresponding plurality of slots 483, thereby allowing coupling air exit bracket 482 with condenser 488 and funnel 484. According to some embodiments, the plurality of teeth may be asymmetrically positioned. According to some embodiments, the plurality of teeth may differ in, among others, size, structure, orientation, and the like, such that of the plurality of teeth may be inserted into each of the plurality of slots 473, allowing coupling at a preferred orientation only.

According to some embodiments, funnel 484 may include one or more openings 485. According to some embodiments, one or more openings 485 are adapted to receive one or more sensors (not shown) therein. According to some embodiments, the one more sensors are configured to measure or sense environmental or operating parameters of the system. According to some embodiments, the one or more sensors may include, among others, pressure sensors, internal temperate sensors in various units, relative humidity sensors, air/fluid flow speed and/rate, pump level, vacuum levels, liquid water removal rates, volume of the precipitated liquid water, or any combination thereof. Each possibility is a separate embodiment.

According to some embodiments, aerodynamic structure 480 may be positioned within and/or at the entrance of the water precipitation unit, to facilitate cooling thereof. In some embodiments, utilizing condenser 488 in aerodynamic structure 480 may increase the cooling efficiency thereof.

According to some embodiments, and as schematically depicted in FIG. 4F, a fluid flow direction through aerodynamic structure 480 is marked by an arrow F. According to some embodiments, fluid flowing therethrough flows from air exit bracket 482, through condenser 488 and into fan 486. According to some embodiments, the fluid flow direction through aerodynamic structure 480 may be reversable. According to some embodiments, the fluid flow direction through aerodynamic structure 480 may be periodically reversed. According to some embodiments, the periodically reversable operation aerodynamic structure 480 advantageously enables capturing the remnant water vapor in the desiccant unit in a first fluid flow direction, and periodically releasing the remnant water vapor captured in the desiccant unit when the fluid flow direction is reversed by aerodynamic structure 480. According to some embodiments, when the fluid flow is reversed, a heating element may be activated to heat at least a portion of the desiccant unit, thereby releasing the remnant water vapor thereof. According to some embodiments, the heating element may be activated when a desiccant of the desiccant unit is substantially full (e.g., according to the one or more sensors, and/or calculations configured to predict the remnant water vapor amount in the desiccant, and the like).

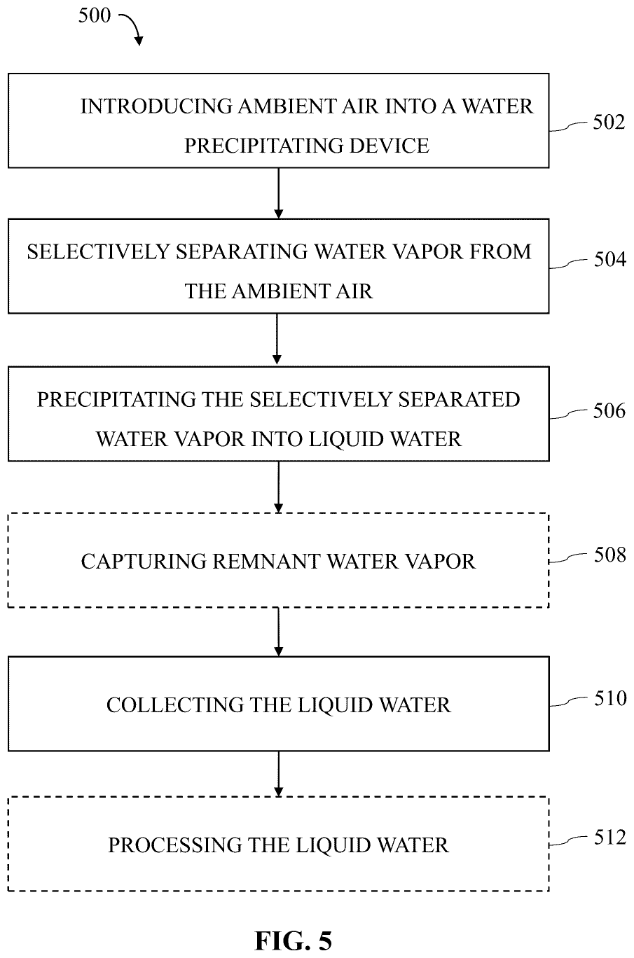

Reference is now made to FIG. 5, which shows a flowchart diagram 500 of a method for precipitating water from ambient air, according to some embodiments.

In step 502, atmospheric/ambient air flow is introduced into a water vapor separation unit of a water precipitating device. In some embodiments, air moving devices may be utilized for facilitating the ambient air flow. According to some embodiments, the air moving devices may include low power air moving devices, such as fans, blowers, and the like.

According to some embodiments, the device may include a control unit, configured to control and adjust operating parameters thereof.

In step 504, water vapor originating from the ambient air is selectively separated/transferred from the water vapor separation unit into a water precipitation unit. According to some embodiments, the water vapor is separated through one or more selective membranes, configured for selectively separating/transferring the water vapor while essentially blocking other components of the ambient air, such as but not limited to, bacteria, viruses, air-borne contaminations, and the like, or any combination thereof.

According to some embodiments, the one or more selective membranes may include or be made, among others, of Nafion. According to some embodiments, the one or more selective membranes may include a tubular configuration, such as a plurality of tubes. According to some embodiments, the one or more selective membranes may include a planar configuration, such as a plurality of sheets.

In step 506, the selectively separated water vapor (i.e., gaseous phase) is precipitated into liquid water droplets in the water precipitation unit.

According to some embodiments, the precipitation is performed by a plurality of cooling elements positioned in a water precipitation unit of the device. According to some embodiments, the water vapor is cooled to reach a dew point, and is consequently condensed into the liquid phase of water.

According to some embodiments, the cooling elements include a cooling fluid, configured to cool the water vapor until dew point conditions are reached. According to some embodiments, the precipitation of the water vapor into liquid water is performed on a cooling surface of the plurality of cooling elements. According to some embodiments, the cooling surface includes an outer super hydrophobic layer, coating or surface. According to some embodiments, the cooling surface is configured to promote fast release of the liquid water droplets formed thereon.

In step 508, which is an optional step according to some embodiments, the method may include capturing remnant water vapor in a desiccant unit. According to some embodiments, the remnant water vapor captured in the desiccant unit may be periodically released therefrom by heating thereof and collecting the released remnant water vapor from the desiccant unit.

According to some embodiments, the method may include enriching the ambient air flow introduced into the water vapor separation unit with humidity (step not shown). According to some embodiments, enriching the ambient air flow may include forming an additional fluid path (i.e. a second fluid path) in the device.

According to some embodiments, the method may include enriching the ambient air flow by capturing remnant water vapor in a desiccant unit, and periodically reversing the fluid flow direction to release the remnant water vapor captured in the desiccant unit (step not shown). Put differently, in some embodiments, enriching the ambient air flow introduced into the water vapor selectivity unit may be performed by using the same flow fluid path, wherein the fluid flow direction thereof is periodically reversed. According to some embodiments, the method may include periodically reversing the fluid flow direction by using an air moving device. According to some embodiments, the air moving device may have an aerodynamic structure. According to some embodiments, the reversing may include periodically heating at least a portion of a desiccant unit to release remnant water vapor therefrom. According to some embodiments, the reversing may include recirculating back the remnant water vapor released from the desiccant unit into the water vapor separation unit. According to some embodiments, the reversing may be devoid of removing the desiccant unit from the disclosed device, thereby reducing the energy consumption.

In step 510, the liquid water is collected in a collection unit of the device. According to some embodiments, the collection unit includes a container configured to retain/deliver the liquid water upon request.

In step 512, which is an optional step, the liquid water may undergo further processing. According to some embodiments, the processing may include liquid water collection or delivery into reservoirs, containers, bottles, ionizing or otherwise enriching with elements/substances, and the like, or any combination thereof. According to some embodiments, the method may further include sensing or measuring one or more parameters, selected from: ambient temperature, relative humidity. barometric pressure, partial water vapor pressure, or any combination thereof.

Unless otherwise defined, all technical and scientific terms used herein have the same meaning as commonly understood by one of ordinary skill in the art to which this disclosure pertains. In case of conflict, the patent specification, including definitions, governs. As used herein, the indefinite articles “a” and “an” mean “at least one” or “one or more” unless the context clearly dictates otherwise.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable sub-combination or as suitable in any other described embodiment of the disclosure. No feature described in the context of an embodiment is to be considered an essential feature of that embodiment, unless explicitly specified as such.

Although stages of methods according to some embodiments may be described in a specific sequence, methods of the disclosure may include some or all of the described stages carried out in a different order. A method of the disclosure may include a few of the stages described or all of the stages described. No particular stage in a disclosed method is to be considered an essential stage of that method, unless explicitly specified as such.

Although the disclosure is described in conjunction with specific embodiments thereof, it is evident that numerous alternatives, modifications and variations that are apparent to those skilled in the art may exist. Accordingly, the disclosure embraces all such alternatives, modifications and variations that fall within the scope of the appended claims. It is to be understood that the disclosure is not necessarily limited in its application to the details of construction and the arrangement of the components and/or methods set forth herein. Other embodiments may be practiced, and an embodiment may be carried out in various ways.

The phraseology and terminology employed herein are for descriptive purpose and should not be regarded as limiting. Citation or identification of any reference in this application shall not be construed as an admission that such reference is available as prior art to the disclosure. Section headings are used herein to case understanding of the specification and should not be construed as necessarily limiting.

What is claimed is:

1. A device for generating water from ambient air, the device comprising:
a water vapor separation unit, comprising one or more selective membranes configured to selectively separate/transfer water vapor from the ambient air passing along the one or more selective membranes; and
a water precipitation unit comprising a plurality of cooling elements, configured for precipitating the selectively separated water vapor to allow collection of precipitated water droplets in a water collection unit;
wherein a continuous gradient of water vapor concentration and/or pressure is maintained across the one or more selective membranes;
wherein each of the one or more selective membranes of the water vapor separation unit is adjacent to at least one of the plurality of cooling elements of the water precipitation unit.

2. The device of claim 1, wherein each of the one or more selective membranes is selectively permeable to water vapor and is essentially impermeable to bacteria, viruses or other airborne contaminants.

3. The device of any one of claims 1-2, wherein the one or more selective membranes include or made of a non-porous membrane.

4. The device of any one of claims 1-3, wherein each of the one or more selective membranes is made of or includes one or more of: Nafion, Aquivion, Flemion and Perfluorosulfonic acid.

5. The device according to any one of claims 1-4, wherein the one or more selective membranes comprise or made of non-porous membranes impregnated with Nafion solution.

6. The device of any one of claims 1-5, wherein each of the one or more selective membranes is arranged parallelly to the longitudinal axis thereof.

7. The device of any one of claims 1-6, wherein the one or more selective membranes are arranged in a periodic and/or close packed configuration.

8. The device according to any one of claims 1-7, wherein the one or more selective membranes are in the form of a plurality of tubes, a plurality of sheets, or a combination thereof.

9. The device of claim 8, wherein each of the plurality of tubes having a diameter of at least about 1.5 mm.

10. The device of claim 8, wherein each of the plurality of tubes having a diameter in the approximate range of 3-5 mm.

11. The device of any one of claims 8-10, wherein each of the plurality of tubes having a length to diameter ratio of at least about 100 to 1.

12. The device of any one of claims 1-8, wherein the distance between each of the plurality of sheets is in the approximate range of 2-6 mm.

13. The device of any one of claims 1-12, wherein the ambient air flow speed through the water vapor separation unit is at least about 5 m/sec.

14. The device of any one of claims 1-13, wherein the plurality of cooling elements comprise a cooling surface.

15. The device of claim 14, wherein the distance between an outer surface each of the one or more selective membranes and the cooling surface is in the approximate range of 3-4 mm.

16. The device of any one of claims 14-15, wherein the cooling surface comprises an outer super hydrophobic layer, coating or surface.

17. The device of any one of claims 14-16, wherein the cooling surface comprises one or more islands of hydrophilic material to facilitate nucleation of liquid water droplets.

18. The device of any one of claims 14-17, wherein the plurality of tubes and the cooling elements are at least partially concentric.

19. The device of any one of claims 1-18, wherein the plurality of cooling elements are tubular elements comprising a cooling fluid in a cavity thereof.

20. The device of any one of claims 1-19, wherein the plurality of cooling elements is configured to allow fast release of the precipitated water droplets therefrom.

21. The device of any one of claims 1-20, wherein the precipitating of water vapor into liquid water (i.e., condensation) in the water precipitation unit is facilitated by cooling the water vapor to reach a dew point and consequent condensing the water vapor to form the liquid water.

22. The device of any of claims 1-21, further comprising one or more of: a pump an air moving device, or any combination thereof.

23. The device of any one of claims 1-22, further comprising a control unit, configured to control operation of the device.

24. The device of any one of claims 1-23, further comprising one or more sensors configured to measure various operating parameters of the device, and/or environment-related parameters.

25. The device of claim 24, wherein the operating parameters and/or the environment-related parameters are selected from: ambient temperature, relative humidity, barometric pressure, internal temperature in various compartments of the device, air flow speed to and/or within the device, pump level, pump throughput, pressure gradient, cooling level, vacuum levels, water removal rate, amount of generated water, daylight time, or any combination thereof.

26. The device of any one of claims 1-25, wherein the water collection unit is positioned at least partially beneath the water precipitation unit.

27. The device of any one of claims 1-26, wherein the device is portable.

28. The device of any one of claims 1-27, further comprising a desiccant unit configured to extract remnant water vapor.

29. A method for generating water from ambient air, the method comprising:
introducing an ambient air flow into a water vapor separation unit, the water vapor separation unit comprising one or more selective membranes configured to selectively separate/transfer water vapor from the ambient air passing along the one or more selective membranes;
precipitating the selectively separated/transferred water vapor into liquid water droplets in a water precipitation unit by a plurality of cooling elements;
collecting the liquid water droplets in a water collection unit.

30. The method of claim 29, wherein precipitating the water vapor into liquid water is performed by cooling the selectively separated/transferred water vapor to reach a dew point, and consequent condensing the water vapor to form the liquid water.

31. The method of any one of claims 29-30, wherein precipitating the water vapor into liquid water is performed on a cooling surface, the cooling surface comprises an outer super hydrophobic layer, coating or surface.

32. The method of any one of claims 29-31, further comprising enriching the ambient air flow introduced into the water vapor separation unit with humidity.

33. The method of any one of claims 29-32, further comprising periodically reversing a fluid flow direction, wherein the reversing comprises:
reversing the fluid flow direction of an air moving device;
heating at least a portion of a desiccant unit to release remnant water vapor therefrom; and
recirculating back the remnant water vapor released from the desiccant unit into the water vapor separation unit.

34. The method of any one of claims 29-33, further comprising processing of the liquid water.

35. The method of any one of claims 29-34, further comprising sensing or measuring one or more parameters, selected from: ambient temperature, relative humidity. barometric pressure, partial water vapor pressure, or any combination thereof.
